(19) United States
(12) Patent Application Publication
(10) Pub. No.: US 2001/0019481 A1
(43) Pub. Date: Sep. 6, 2001

(54) Luminaire for elongate lamp

(75) Inventor: Christian Bartenbach, Aldrans (AT)

Correspondence Address: OSTROLENK FABER GERB & SOFFEN, 1180 AVENUE OF THE AMERICAS, NEW YORK, NY, 100368403

(73) Assignee: Gebr. Ludwig GmbH

(21) Appl. No.: 09/748,465

(22) Filed: Apr. 9, 2001

(30) Foreign Application Priority Data
Dec. 27, 1999 (AT) A 2190/99

(51) Int. Cl. F21S 4/00; F21V 7/00

(52) U.S. Cl. 362/217; 362/296; 362/297; 362/346

(57) ABSTRACT

Luminaire for an elongate lamp, having longitudinal reflectors running parallel to the lamp and having a multiplicity of spaced-apart transverse lamellae which have a bottom, tapering region and of which the bottom edge is curved, where the cross section of the bottom, tapering region (4) is of the same shape over the width of the transverse lamellae (3), and where the edges (8), which bound the bottom, tapering region (4) in the upward direction, coincide, in terms of curvature, with the bottom edge (9) of the transverse lamellae (3).

The present invention relates to a luminaire for an elongate lamp, having longitudinal reflectors running parallel to the lamp and having a multiplicity of spaced-apart transverse lamellae which have a bottom, tapering region and of which the bottom edge is curved.

Such a luminaire is known from U.S. Pat. No. 5,758,954. The bottom, tapering region of the transverse lamellae here has a changing curvature since the bottom edge of the transverse lamellae is curved, whereas the edges which bound the bottom, tapering region in the upward direction are of rectilinear design. This geometry has an adverse effect on the lighting distribution.

The object of the invention is thus to improve the lighting distribution of the known luminaire.

This is achieved according to the invention in that the cross section of the bottom, tapering region is of the same shape over the width of the transverse lamellae, and in that the edges which bound the bottom, tapering region in the upward direction coincide, in terms of curvature, with the bottom edge of the transverse lamellae.

The three-dimensional shaping of the bottom region of the transverse lamellae is produced, from a geometrical point of view, in that a predetermined segment of a curve, which is preferably curved parabolically, is displaced in a plane normal to the longitudinal axis of the lamp, with constant alignment, along the curved bottom edge of the transverse lamellae. The highest point here is located in the center of the transverse lamellae, whereas the bottom edge slopes down in the direction of the borders of the transverse lamellae. The cross sections through the transverse lamellae are of the same shape and are merely offset in height in relation to one another. Overall, the new lamella shape makes it possible to achieve, even with elongate light sources, for example fluorescent tubes, an essentially rotationally symmetrical light distribution and screening behavior.

It is particularly straightforward from a design point of view if the top region of the transverse lamellae, said top region being located above the edges, is of a constant thickness. It is favorable here from a lighting point of view if the thickness of the transverse lamellae is approximately half the diameter of the lamp.

Excess limiting of the radiation in the longitudinal direction of the luminaire can be avoided in that the vertical height difference of the bottom edge of the transverse lamellae is approximately a quarter of the diameter of the lamp.

In order to provide a free space for the lamp, finally, it is preferably provided that the top surface of the transverse lamellae, as seen in the longitudinal direction of the lamp, is indented in the form of a V in the central region.

Further features and details of the present invention can be gathered from the following description of the figures, in which:

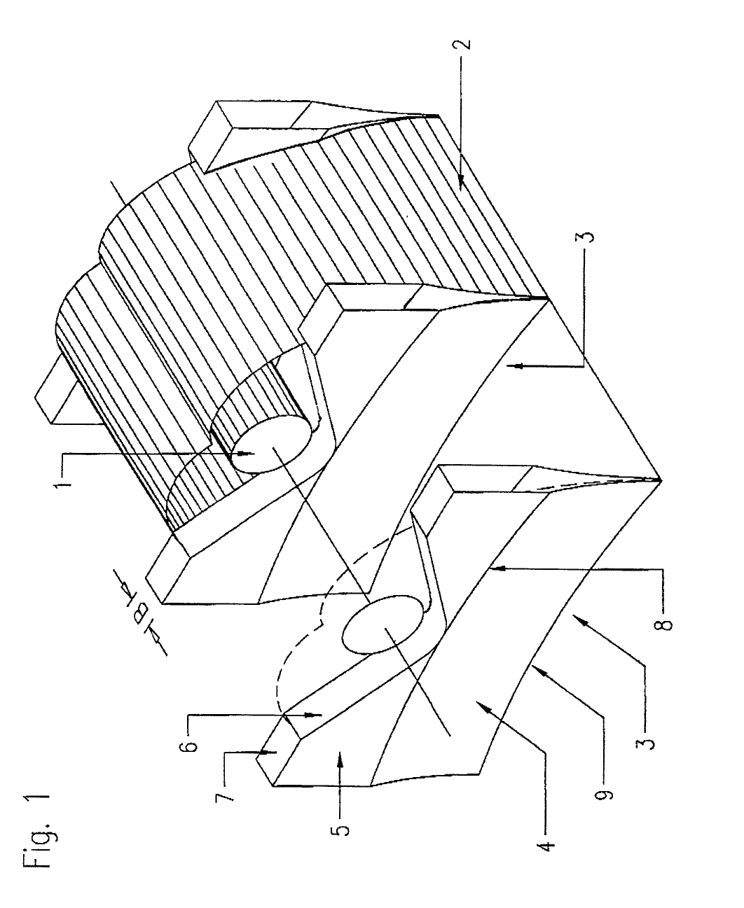

FIG. 1 shows a perspective view of a luminaire according to the invention, and

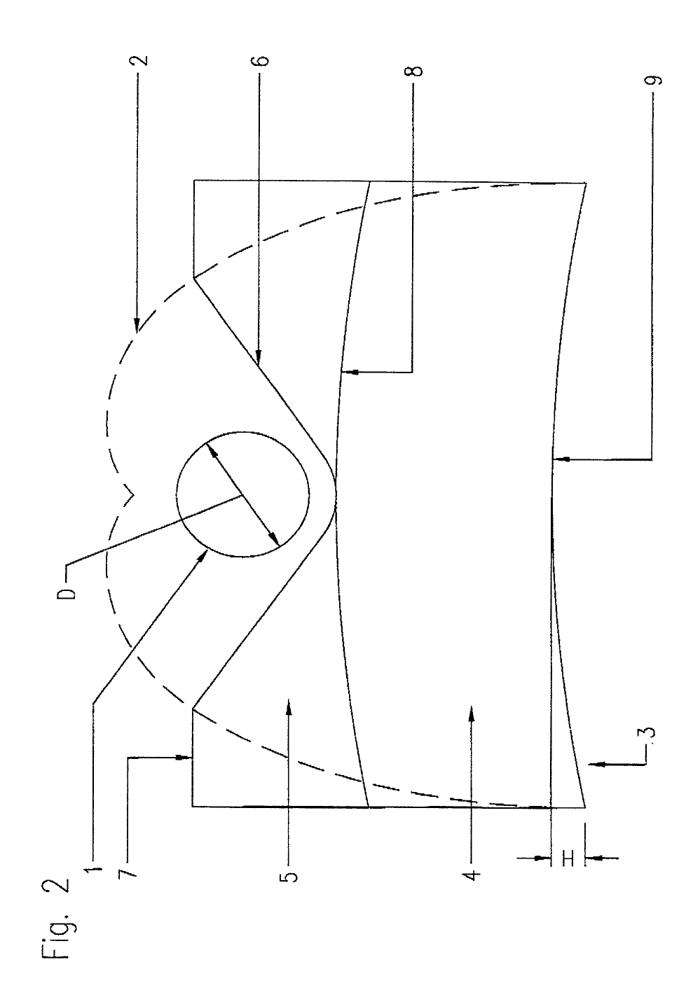

FIG. 2 shows a front view of a transverse lamella.

The luminaire according to the invention has, as its light source, an elongate lamp 1. Extending parallel to said lamp 1 are longitudinal reflectors 2 which are designed symmetrically in relation to the longitudinal center plane.

In FIG. 1, the longitudinal reflectors 2 are depicted merely in the region between two transverse lamellae 3, but they extend over the entire luminaire. In the top region, the elongate reflectors 2 are in involute form, with the result that all the impinging rays are reflected downward past the lamp 1.

Transverse lamellae 3 are arranged at regular intervals in planes normal to the longitudinal axis of the lamp 1. The transverse lamellae 3 are produced from high-grade aluminum sheet material.

In the bottom region 4, between the bottom edge 9 and edges 8, which bound the bottom region 4 in the upward direction, the transverse lamellae 3 taper conically, the surfaces being curved concavely. In specific terms, the curvature is parabolic or the like and is produced by transverse displacements along the bottom edge 9. The transverse displacement takes place in a plane normal to the center axis of the lamp 1, the alignment of the parabolic curved segment which is displaced transversely remaining unchanged. In this way, the curvature of the bottom edge 9 coincides with the curvature of the edges 8. The vertical height difference H depicted in FIG. 2 is a quarter of the diameter D of the lamp 1.

In the region 5 above the edges 8, the side surfaces of the transverse lamellae 3 run parallel to one another, this resulting in an unchanged thickness B in the top region 5 of the transverse lamellae 3. This thickness B is around half the diameter D of the lamp 1.

The top surface 6 of the transverse lamellae 3, outside the longitudinal reflector, runs horizontally in the border zones 7 and, in the longitudinal reflector, is indented in the form of a V in the direction of the center, this resulting in a free space for the lamp 1. In this case, the indent reaches downwards essentially as far as the edges 8.

1. A luminaire for an elongate lamp, having longitudinal reflectors running parallel to the lamp and having a multiplicity of spaced-apart transverse lamellae which have a bottom, tapering region and of which the bottom edge is curved, wherein the cross section of the bottom, tapering region (4) is of the same shape over the width of the transverse lamellae (3), and wherein the edges (8), which bound the bottom, tapering region (4) in the upward direction, coincide, in terms of curvature, with the bottom edge (9) of the transverse lamellae (3).

2. The luminaire as claimed in claim 1, wherein the bottom, tapering region (4) of the transverse lamellae (3) is curved concavely on both sides.

3. The luminaire as claimed in claim 2, wherein the bottom, tapering region (8) of the transverse lamellae (3) is curved parabolically on both sides.

4. The luminaire as claimed in one of claims 1 to 3, wherein the top region (5) of the transverse lamellae (3) said top region being located above the edges (8) , is of a constant thickness (B).

5. The luminaire as claimed in claim 4, wherein the thickness (B) of the transverse lamellae (3) is approximately half the diameter (D) of the lamp (1).

6. The luminaire as claimed in one of claims 1 to 5, wherein the bottom edge (9) of the transverse lamellae is curved in the form of an arc of a circle.

7. The luminaire as claimed in one of claims 1 to 6, wherein the vertical height difference (H) of the bottom edge (9) of the transverse lamellae (3) is approximately a quarter of the diameter (D) of the lamp (1).

8. The luminaire as claimed in one of claims 1 to 7, wherein the top surface (6) of the transverse lamellae (3), as seen in the longitudinal direction of the lamp (1), is indented in the form of a V in the central region and runs horizontally in the border zones (7).
